(19) United States
(12) Patent Application Publication
(10) Pub. No.: US 2016/0287028 A1
(43) Pub. Date: Oct. 6, 2016

(54) Tubular Toothpaste Tube Stand With Brushing Timer

(71) Applicant: Daniel Patrick Andrews, Westminster, MD (US)

(72) Inventor: Daniel Patrick Andrews, Westminster, MD (US)

(21) Appl. No.: 14/672,265

(22) Filed: Mar. 30, 2015

(51) Int. Cl. A47K 5/18; G04F 1/06; B65D 35/04; B65D 35/56; B65D 35/24

(52) U.S. Cl. CPC A47K 5/18; B65D 35/56; B65D 35/24; B65D 35/04; G04F 1/06

(57) ABSTRACT

A rigid material, preferably recycled plastic, Tubular Toothpaste Tube Stand with Brushing Timer is a countertop dental hygiene appliance. It is comprised of a vertically arranged, open top and open bottom, tubular toothpaste tube stand with an attached, stationary, sand/oil liquid timer hourglass to provide the user a visual gauge to determine elapsed brushing time. The appliance also assists with concentrating toothpaste, within the toothpaste tube, toward the tube's nozzle end. Also, the appliance can be made into various decorative shapes, and, can employ decorative graphics to attract users. It can be easily assembled as well.

### BACKGROUND OF THIS INVENTION

This invention relates to a dental hygiene appliance.

Specifically, this invention relates to a Tubular Toothpaste Tube Stand with Brushing Timer. This invention provides two primary functions, viz; vertical toothpaste tube placement and a brushing timer. To extract toothpaste from a toothpaste tube, the toothpaste must be extruded through the tube's nozzle end using applied pressure on the tube's exterior. When not in use, toothpaste tubes are often laid horizontally, which does not necessarily concentrate the toothpaste, within the tube, toward the nozzle end of the tube. Hence, vertical toothpaste tube placement assists with concentrating the toothpaste, within the tube, toward the nozzle end of the tube by gravity, and vertical tube positioning also conveniently arranges the tube whereby the user may apply grasping pressure to the tube's heat-fused end, thereby further concentrating the toothpaste toward the tube's nozzle end.

According to the American Dental Association, proper teeth-brushing is good dental hygiene and is most effective when brushing occurs over a time period of approximately two minutes. Accordingly, a sand/oil liquid timer hourglass is attached to the tubular toothpaste tube stand and provides the user a visual gauge to determine elapsed brushing time. The inventor chose to offer a simplistic tubular design whereby the attached sand/oil liquid timer hourglass is activated by vertically rotating the entire appliance 180 degrees, and, the appliance is easy to manufacture and use.

Therefore, the principle objective of the present invention is to provide a tubular toothpaste tube stand with an attached sand/oil liquid timer hourglass, which is intended to assist people while timing their brushing routine.

Another objective of the present invention is to provide a tubular toothpaste tube stand which assists in concentrating the toothpaste, within the toothpaste tube, toward the tube's nozzle end, for readily dispensing the toothpaste.

Another objective of the present invention is to provide a tubular stand which accepts a plurality of toothpaste tube lengths.

Another objective of the present invention is to provide a tubular stand which accepts a plurality of toothpaste tube nozzle end caps.

Another objective of the present invention is to provide a tubular toothpaste tube stand of various shapes.

Another objective of the present invention is to provide a decorative tubular toothpaste tube stand.

Another objective of the present invention is to provide a decorative tubular toothpaste tube stand which attracts children and young adults.

Another objective of the present invention is to provide a tubular toothpaste tube stand and timer assembly kit for interactive learning for school children during health related classes.

Another objective of the present invention is to promote proper dental hygiene.

Another objective of the present invention is to provide a recyclable plastic tubular toothpaste tube stand.

Another objective of the present invention is to provide a ceramic tubular toothpaste tube stand.

Lastly, another objective of the present invention is to provide an easily cleaned tubular toothpaste tube stand.

### BRIEF DESCRIPTION OF THE INVENTION

The Tubular Toothpaste Tube Stand with Brushing Timer is a practical and decorative bathroom countertop appliance which may aid with proper dental hygiene. It provides for vertical placement of a toothpaste tube to facilitate the concentration of toothpaste, within the toothpaste tube, toward the tube's nozzle end. The conveniently attached, sand/oil liquid timer hourglass-brushing timer is actuated by rotating the entire tubular toothpaste tube stand vertically 180 degrees. The sand/oil liquid timer hourglass provides the user a visual gauge to determine elapsed brushing time. Also, the design allows for easy cleaning when compared to enclosed bottom toothpaste tube stands, and uses decorative graphics to attract users.

### DESCRIPTION OF DRAWINGS

FIG. 1 is shown on sheet numbered 1-6 as a front page perspective view of the Tubular Toothpaste Tube Stand with Brushing Timer; and

FIG. 2 is shown on sheets numbered 2-6, 3-6, 4-6, 5-6 as plan view top, plan view bottom, elevation view and perspective view, respectively, of the Tubular Toothpaste Tube Stand with Brushing Timer.

FIG. 3 is shown on sheet numbered 6-6 as a perspective view of the Tubular Toothpaste Tube Stand with Brushing Timer with a vertically standing toothpaste tube.

### DESCRIPTION OF THE INVENTION

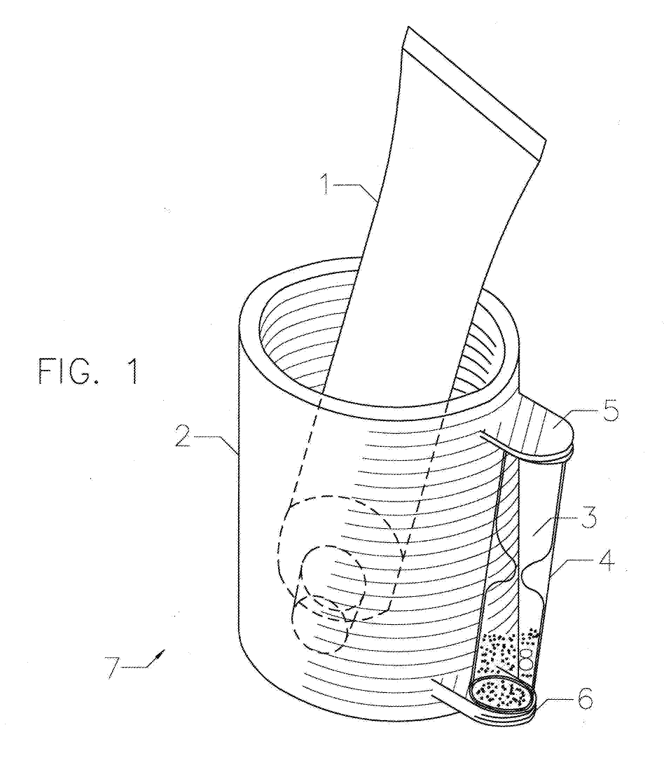

FIG. 1 shows the toothpaste tube 1, the tubular toothpaste tube stand 2 formed of one piece construction, preferably recycled plastic, (but may be constructed of other rigid materials including new resin plastic, ceramic, glass and metal), sand/oil liquid 8 timer hourglass brushing timer 3 completely enclosed within a clear plastic protective safety canister 4, adhesively attached to, and, between an upper mounting tab 5 and lower mounting tab 6, and is intended to be vertically placed on the top surface of a bathroom countertop 7 where people routinely brush and clean their teeth.

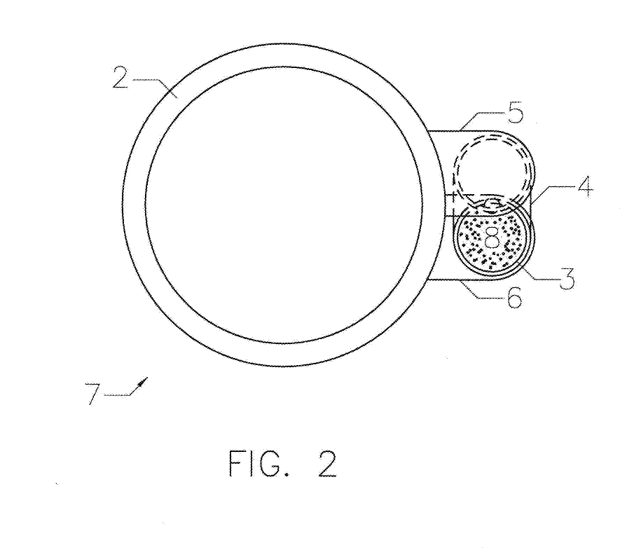

FIG. 2 shows in detail the tubular toothpaste tube stand 2 formed of one piece construction, preferably recycled plastic, (but may be constructed of other rigid materials including new resin plastic, ceramic, glass and metal), which can have varying tubular shapes, is open-ended and vertically arranged, with an approximate 2⅝ inch tubular diameter, an approximate ¼ inch tubular wall thickness, and is of varying tubular heights to accept a plurality of toothpaste tubes 1. Manufactured toothpaste tubes range in length from approximately 3 inches to approximately 8 inches, all of which can fit in this appliance.

The design allows for the vertical placement of a toothpaste tube 1 within the tubular stand 2, so the toothpaste tube's nozzle end is placed downward within the tubular stand 2. This placement facilitates the gravitational concentration of the toothpaste, within the tube 1, toward the nozzle end. This positions the toothpaste tube 1 with its heat-fused end vertically upward within the tubular stand 2 and allows the user to apply grasping pressure to the toothpaste tube 1 near the heat-fused tube end, further concentrating the toothpaste, within the tube 1, toward the nozzle end.

A sand/oil liquid timer hourglass 3 is completely enclosed within a clear plastic protective safety canister 4, and has an approximate diameter of ½ inch, and an approximate height of 3 inches, and is adhesively attached to upper mounting tab 5 and lower mounting tab 6 on the side of the tubular stand 2. The sand/oil liquid 8 timer hourglass 3 and protective safety canister 4 are mounted at a 10 degree zenith angle with respect to the vertical axis of the tubular stand 2. This angular placement facilitates the user's view of the sand/oil liquid 8 timer hourglass 3 when viewed from a position above the countertop 7. The sand/oil liquid 8 timer hourglass 3 is actuated when the user picks up the tubular stand 2 from the countertop 7 and rotates the entire appliance vertically 180 degrees, thereby placing the tubular stand 2 on its opposite end on top of the countertop 7.

Decorative designs will be placed on the front and back of the tubular toothpaste tube stand 2. The graphics will be displayed upward facing on the front side, and upside-down (inverted) facing on the back side, so when the appliance is rotated 180 degrees vertically, a readable and/or understandable graphic image will appear to the user.

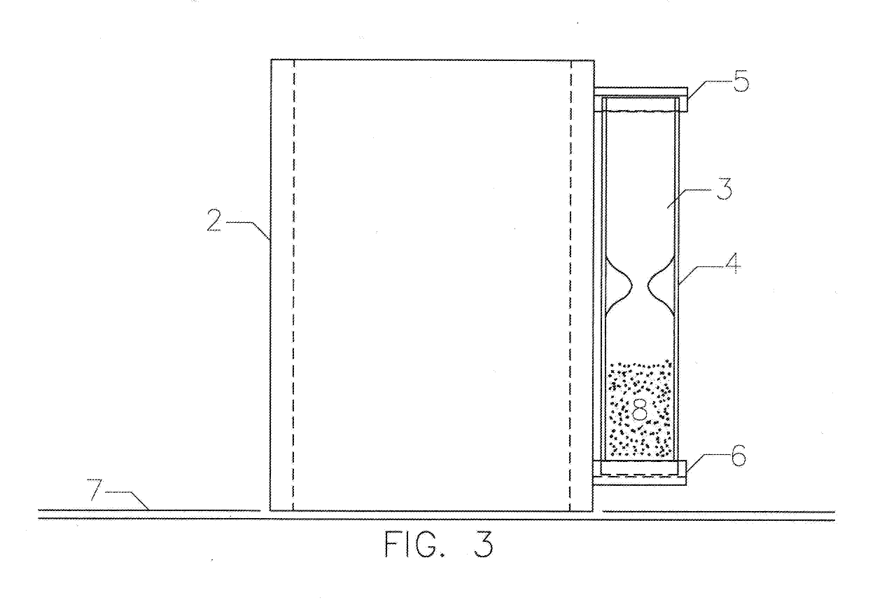

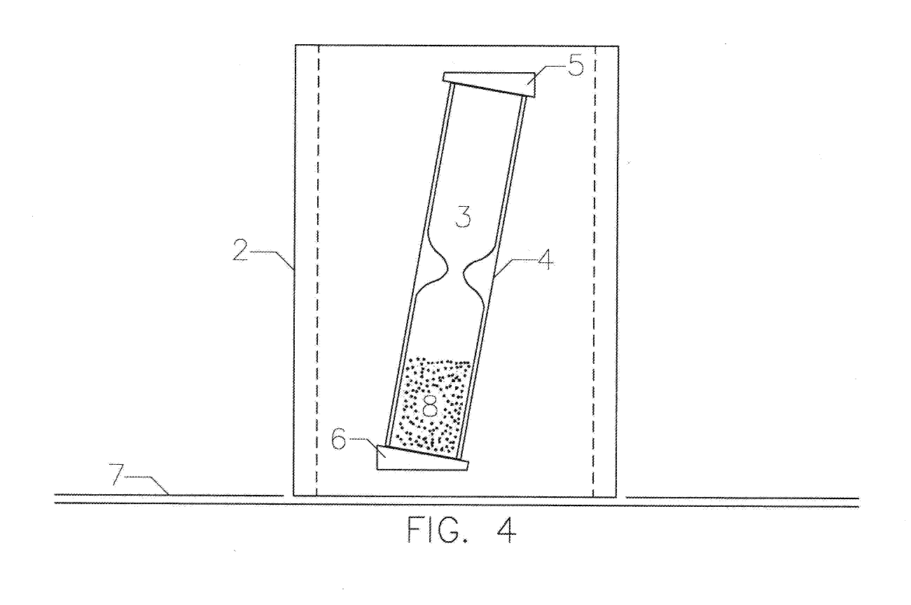

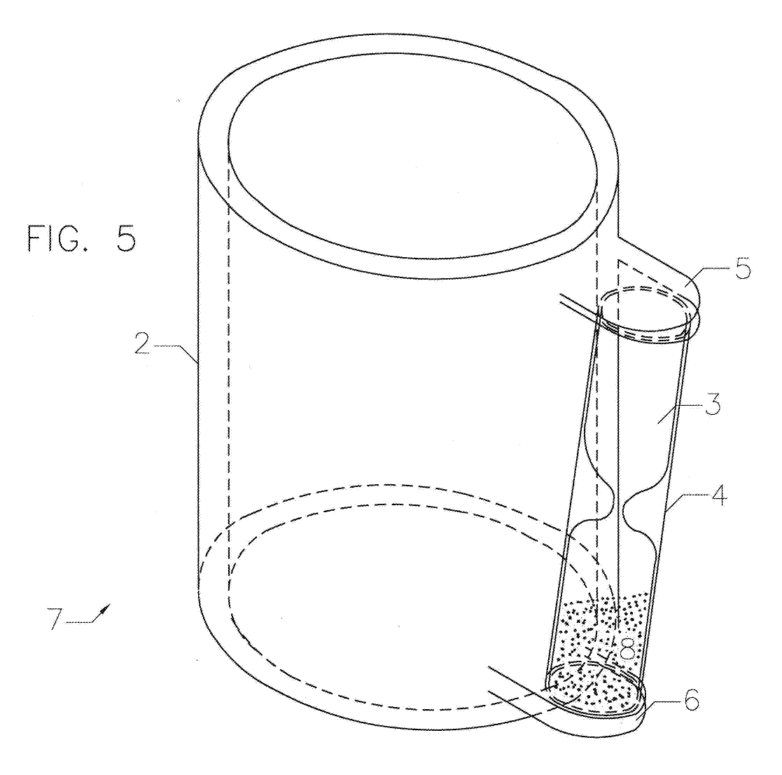

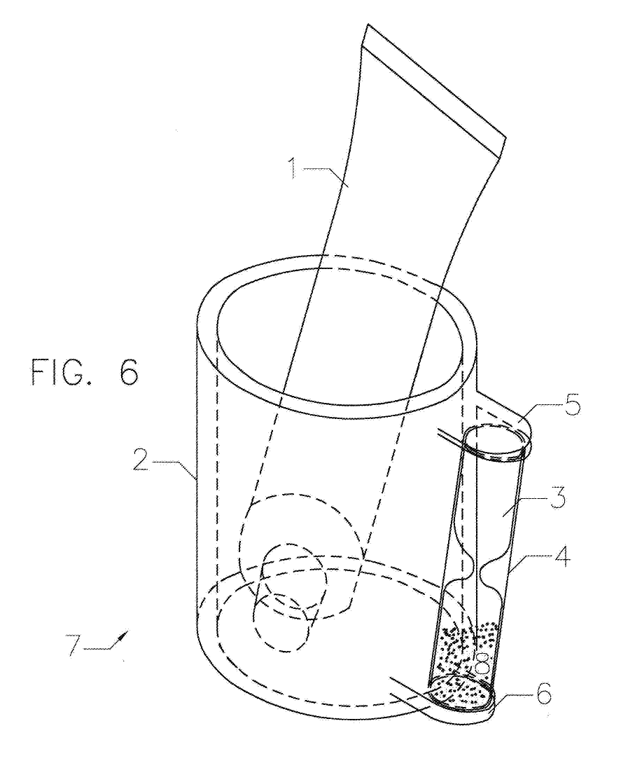

FIG. 3 shows the tubular toothpaste tube stand with brushing timer with a vertically standing toothpaste tube.

In practice, the user grasps the heat-fused end of the toothpaste tube 1 with their fingers and removes the toothpaste tube 1 from the tubular toothpaste tube stand 2.

The user applies toothpaste to their toothbrush.

The user picks up the tubular toothpaste tube stand 2 in its entirety, and vertically rotates the appliance 180 degrees, placing the tubular toothpaste tube stand 2 on its opposite open end. This rotational movement actuates the attached sand/oil liquid timer hourglass 3 causing sand/oil liquid 8 to sift within the sand/oil liquid 8 timer hourglass 3 over a set duration.

The user returns the toothpaste tube 1 into the tubular toothpaste tube stand 2, nozzle end downward, while applying pressure to the toothpaste tube 1 near its heat-fused end. This act helps to concentrate the toothpaste within the toothpaste tube 1 toward the tube's nozzle end. The user brushes their teeth while occasionally glancing at the sand/oil liquid 8 timer hourglass 3 gauging elapsed time. When the sand/oil liquid 8 has completely sifted within the sand/oil liquid 8 timer hourglass 3 from its upper glass bulb into its lower glass bulb, the brushing process is complete.

What is claimed is:

1. A Tubular Toothpaste Tube Stand with Brushing Timer appliance comprising:
a. a tubular toothpaste tube stand with a circular open top and circular open bottom which is usable in both its upright vertical position, and usable when fully rotated 180 degrees from its upside down vertical position, said stand has two protruding upper and lower mounting tabs on the similar outer side of the tubular stand for receiving a stationary and affixed sand/oil liquid timer hourglass which is enclosed within a clear plastic protective safety canister; and
b. said two protruding mounting tabs are positioned at parallel vertical angles, relative to the horizontal axis of said stand, to provide for user viewing of said timer hourglass, from positions above and below said stand, with respect to the horizontal axis of said stand; and
c. said two protruding mounting tabs are positioned to provide three user viewing directions, viz; front, rear and side views of the said timer hourglass, with respect to said mounting tabs on said stand.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. The appliance in claim 1 wherein said stand and said timer provides for an assembly kit for interactive learning for school children during health related classes.

15. The appliance in claim 1 wherein the said stand's pen bottom provides for easier interior stand cleaning when compared to enclosed bottom toothpaste tube stands.

16. The appliance in claim 1 wherein the said stand's open bottom allows water, loose toothpaste, and other debris within said stand to pass through said stand to the countertop surface, on which said stand resides.
